(19) United States
(12) Patent Application Publication
(10) Pub. No.: US 2018/0144289 A1
(43) Pub. Date: May 24, 2018

(54) INVENTORY DEMAND FORECASTING SYSTEM AND INVENTORY DEMAND FORECASTING METHOD

(71) Applicant: INSTITUTE FOR INFORMATION INDUSTRY, Taipei (TW)

(72) Inventor: Jing-Tian SUNG, Taipei City (TW)

(21) Appl. No.: 15/365,962

(22) Filed: Dec. 1, 2016

(30) Foreign Application Priority Data
Nov. 23, 2016 (TW) 105138452

(51) Int. Cl. G06Q 10/08; G06Q 30/02

(52) U.S. Cl. CPC G06Q 10/087; G06Q 30/0202

(57) ABSTRACT

An inventory demand forecasting system comprises a storage and a processor. The storage stores a plurality of material information, an inventory turnover ratio and a service level ratio. The processor configures a demand satisfaction range according to the inventory turnover ratio and the service level ratio. The processor calculates a plurality of best material points corresponding to the material information respectively. The processor adds the best material points located in the demand satisfaction range to a first stock group and adds the best material points located out of the demand satisfaction range to a second stock group.

### CROSS-REFERENCE TO RELATED APPLICATION

This application claims priority to Taiwan Application Serial Number 105138452, filed Nov. 23, 2016, which is herein incorporated by reference.

### BACKGROUND

### Field of Invention

The present invention relates to an inventory demand forecasting system and an inventory demand forecasting method. More particularly, the present invention relates to an inventory demand forecasting system and an inventory demand forecasting method related to an inventory turnover ratio and a service level ratio.

### Description of Related Art

In the new type of market demand, preparing material is more important than preparing product. The factory starts to combine the components or the materials for producing the products after receiving orders. In this way, the factory can further decrease the possibility of hoarding products. However, the amount of material information is at least ten times larger than the amount of product information. Also, multiple kinds of the material information are variable. It is hard to use single forecasting module to predict the demand of these materials. Besides, the small-volume and large-variety production of new market demand type becomes the development trend. How to manage the inventory efficiently to meet the rapid changing of the customer demand becomes the important issue.

Therefore, how to provide suitable inventory demand forecasting system and inventory demand forecasting method for the industrially production management and meet the market demand becomes a problem to be solved.

### SUMMARY

The invention provides an inventory demand forecasting system. The inventory demand forecasting system comprises a storage and a processor. The storage stores a plurality of material information, an inventory turnover ratio and a service level ratio. The processor is coupled to the storage. And, the processor is configured to: configure a demand satisfaction range according to the inventory turnover ratio and the service level ratio; calculate a plurality of best material points respectively corresponding to the material information; add the best material points located in the demand satisfaction range to a first stock group and add the best material points located out of the demand satisfaction range to a second stock group; calculate an initial centroid position of the best material points in the first stock group; generate a plurality of first distance indicators according to the best material points in the second stock group and the initial centroid position; determine a shortest one of the first distance indicators to be a first candidate distance, determine one of the best material points corresponded to the first candidate distance to be a current material point, and add the current material point to the first stock group to generate a current stock group; remove the current material point from the second stock group; and calculate a current centroid position and determine whether the current centroid position is located in the demand satisfaction range; if the current centroid position is located in the demand satisfaction range, generate a plurality of second distance indicators according to the best material points in the second stock group and the current centroid position, determine a shortest one of the second distance indicators to be a second candidate distance, and determine one of the best material points corresponded to the second candidate distance to be the current material point.

On another aspect, the invention provides an inventory demand forecasting method. The inventory demand forecasting method comprises: storing a plurality of material information, an inventory turnover ratio and a service level ratio; configuring a demand satisfaction range according to the inventory turnover ratio and the service level ratio; calculating a plurality of best material points respectively corresponding to the material information; adding the best material points located in the demand satisfaction range to a first stock group and add the best material points located out of the demand satisfaction range to a second stock group; calculating an initial centroid position of the best material points in the first stock group; generating a plurality of first distance indicators according to the best material points in the second stock group and the initial centroid position; determining a shortest one of the first distance indicators to be a first candidate distance, determine one of the best material points corresponded to the first candidate distance to be a current material point, and add the current material point to the first stock group to generate a current stock group; removing the current material point from the second stock group; and calculating a current centroid position and determine whether the current centroid position is located in the demand satisfaction range; if the current centroid position is located in the demand satisfaction range, generate a plurality of second distance indicators according to the best material points in the second stock group and the current centroid position, determining a shortest one of the second distance indicators to be a second candidate distance, and determining one of the best material points corresponded to the second candidate distance to be the current material point.

Through the inventory demand forecasting system and the inventory demand forecasting method can provide the preparation strategy of the materials precisely by considering the inventory turnover ratio and the service level ratio in the same time. Also, it can efficiently adapt the changing market demand, so as to provide the accurate inventory demand forecasting mechanism.

### BRIEF DESCRIPTION OF THE DRAWINGS

The invention can be more fully understood by reading the following detailed description of the embodiment, with reference made to the accompanying drawings as follows:

FIG. 1 illustrates a flow chart of an inventory demand forecasting method according to an embodiment of the present invention;

FIG. 2 illustrates a block diagram of an inventory demand forecasting system according to an embodiment of the present invention;

FIG. 3 illustrates a schematic diagram of a demand satisfaction range according to an embodiment of the present invention;

FIG. 4 illustrates a schematic diagram of a demand satisfaction range according to an embodiment of the present invention;

FIG. 5 illustrates a schematic diagram of selecting forecasting algorithm according to an embodiment of the present invention;

FIG. 6 illustrates a schematic diagram of material information according to an embodiment of the present invention;

FIG. 7 illustrates a schematic diagram of material information according to an embodiment of the present invention; and

FIG. 8 illustrates a schematic diagram of material information according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

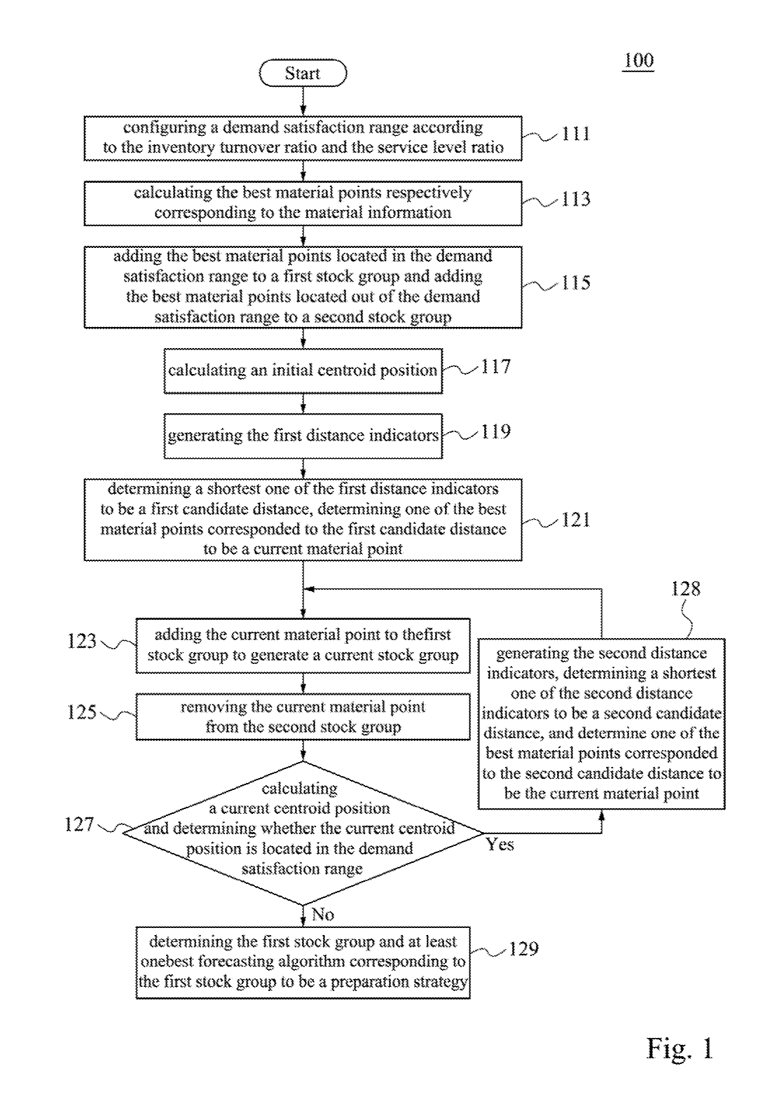

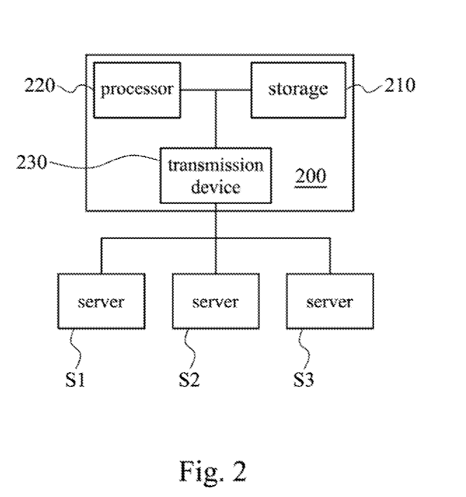

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments. Reference is made to FIGS. 1-2. FIG. 1 illustrates a flow chart of an inventory demand forecasting method 100 according to an embodiment of the present invention. FIG. 2 illustrates a block diagram of an inventory demand forecasting system 200 according to an embodiment of the present invention.

In one embodiment, the inventory demand forecasting system 200 comprises a storage 210 and a processor 220. In one embodiment, the storage 210 can be implemented by using a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains. In one embodiment, the processor 220 can be implemented by using an integrated circuit, such as a microcontroller, a microprocessor, a digital signal processor, an application specific integrated circuit (ASIC), or a logic circuit.

In one embodiment, the inventory demand forecasting system 200 further includes a transmission device 230. In one embodiment, the transmission device 230 can be implemented by using a router chip, a digital processing component, or a network card.

In one embodiment, the processor 220 is coupled to the storage 210. The transmission device 230 is coupled to the storage 210 and the processor 220. In one embodiment, the transmission device 230 is communicatively coupled to the servers S1-S3. The transmission device 230 uses for receiving the material information from the servers S1-S3.

In one embodiment, the storage 210 uses for storing a plurality of material information, an inventory turnover ratio and a service level ratio.

In one embodiment, the service level ratio is determined by an inventory supply directly ratio during a preprocessing period. Wherein, the preprocessing period means the time between establishing the purchase order and receiving the products. For example, a customer establishes the purchase order on 2016 Aug. 1, to order the product A. After receiving the purchase order, the sales company starts to manufacture or assemble the product A. And, the sales company provides the product A to the customer on 2016 Nov. 1 according to the normal operating procedures. In this example, the preprocessing period is three months (from 2016 Aug. 1 to 2016 Nov. 1). Besides, in general, the sales company sells multiple kinds of products. The total service level ratio means the average service level ratio of the multiple kinds of products or materials.

For another example, the sales company starts to assemble the product A after receiving a purchase order. And, the purchase order recites that the sales company should provide one hundred products after one month. However, the materials are not enough to assemble one hundred products. According to the normal operating procedures, only eighty products can be provided after two weeks. Therefore, the sales company needs to order more materials. Considering the shipping time of materials, the sales company will provide the remaining twenty products after five weeks. Thus, the sales company only can provide eighty products of 100 products during the preprocessing period (one month). In this case, the service level ratio is 0.8 (that is, 80/100=0.8).

In one embodiment, the inventory turnover ratio is obtained by dividing a sales quantity of a time interval by an inventory remaining amount of the time interval. For example, from 2016 Aug. 1 to 2016 Aug. 7 (one week), the sales quantity of product A is 300. And, the inventory remaining amount in this week is 150. The inventory turnover ratio is 2 (that is 300/150=2). Besides, in general, the sales company sells multiple kinds of products. The total inventory turnover ratio means the average inventory turnover ratio of the multiple kinds of products or materials.

Therefore, the storage 210 stores multiple kinds of material information (including the history records corresponding to each kind of materials). The processor 220 can calculates the inventory turnover ratio and the service level ratio according to the material information.

In step 111, the processor configures a demand satisfaction range Ra according to the inventory turnover ratio and the service level ratio.

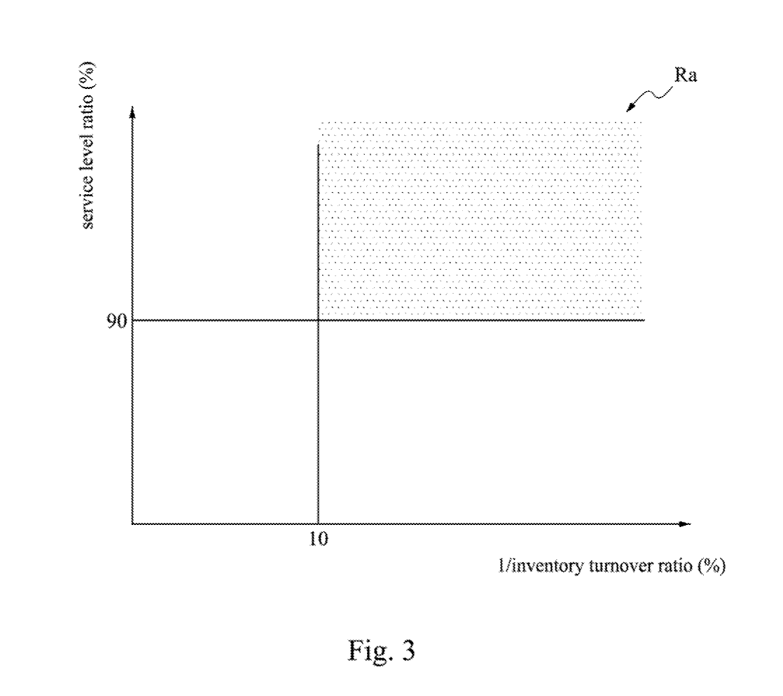

Reference is made to FIG. 3. FIG. 3 illustrates a schematic diagram of a demand satisfaction range Ra according to an embodiment of the present invention. In one embodiment, the processor 220 configures a demand satisfaction range Ra as an area that the service level ratio which is higher than 90% and the one-inventory turnover ratio which is higher than 10%, as shown in FIG. 3.

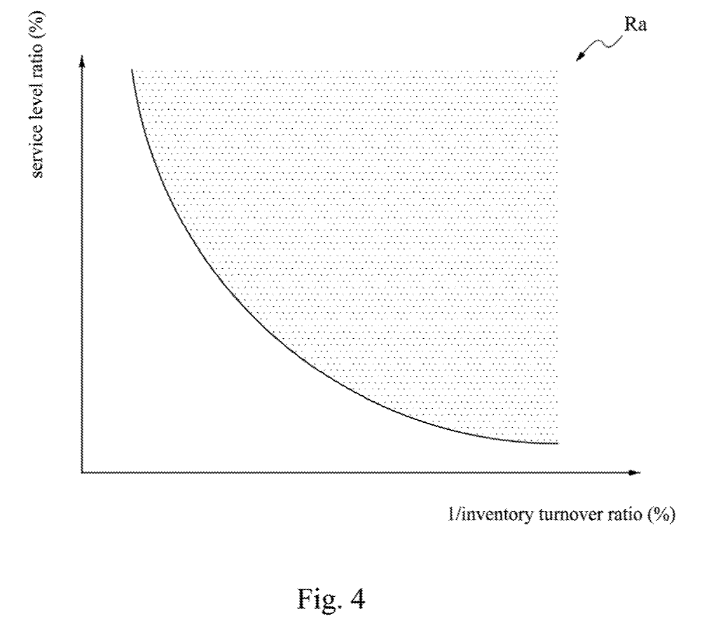

Reference is made to FIG. 4. FIG. 4 illustrates a schematic diagram of a demand satisfaction range Ra according to an embodiment of the present invention. In one embodiment, as shown in FIG. 4, when the processor 220 defines that the one-inventory turnover ratio is x, the service level ratio is y, and the demand satisfaction range Ra can be defined as following function:

y=1−ln(100x)/10

In this way, when the function is satisfied (that is, the service level ratio and the one-inventory turnover ratio of a material is located in the demand satisfaction range Ra), it means that the inventory amount of the material is not too much but still can satisfy the demand of the order.

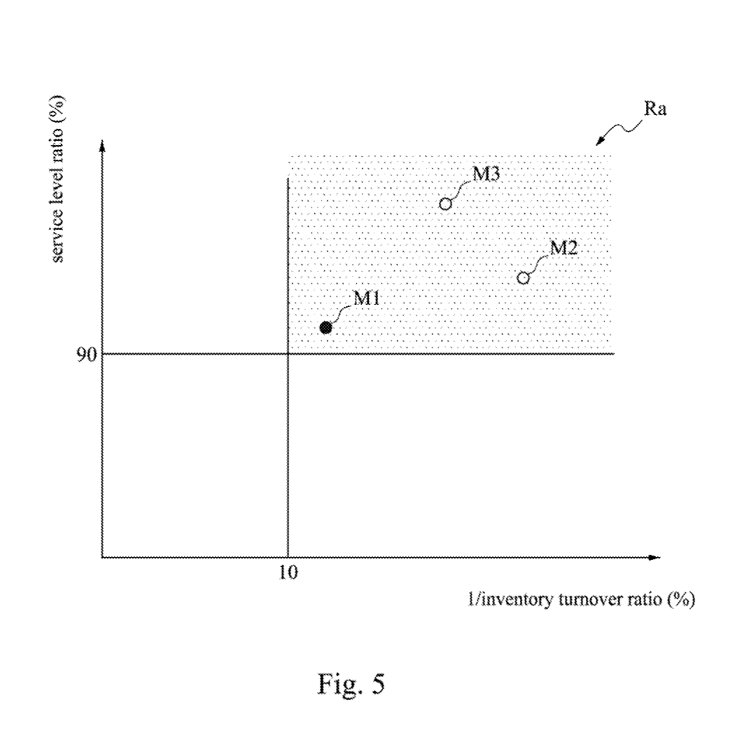

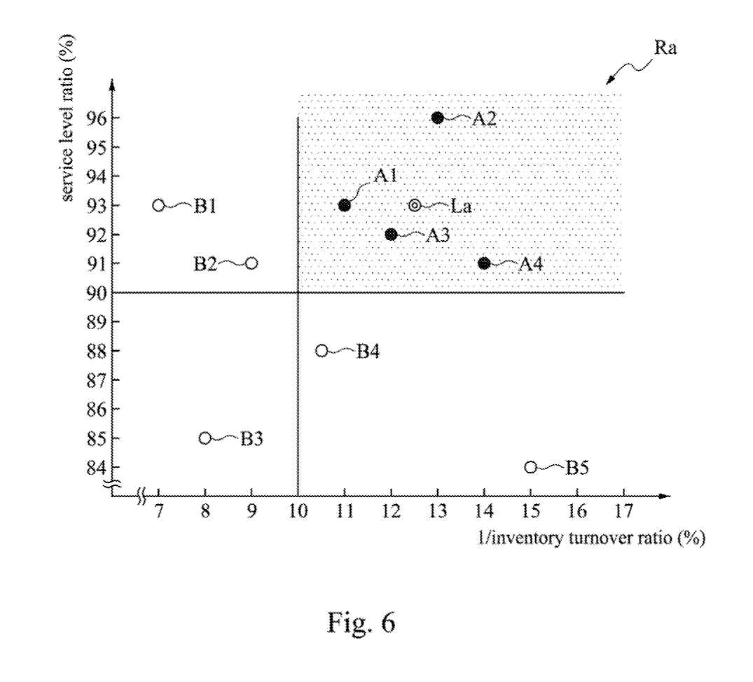

Next, reference is made to FIGS. 5-6. FIG. 5 illustrates a schematic diagram of selecting forecasting algorithm according to an embodiment of the present invention. FIG. 6 illustrates a schematic diagram of material information according to an embodiment of the present invention.

In step 113, the processor 220 calculates a plurality of best material points A1-A4, B1-B5 respectively corresponding to the material information.

In one embodiment, each one of material information can use multiple original forecasting algorithms to forecast the inventory turnover ratio and the service level ratio. As shown in FIG. 5, the inventory turnover ratio and the service level ratio of a material information can be forecasted by auto-regressive and moving average model (ARMA), and the inventory turnover ratio and the service level ratio of the material information corresponds to an initial material points M1. And, the inventory turnover ratio and the service level ratio of the material information can be forecasted by support vector regression (SVR), and the inventory turnover ratio and the service level ratio of the material information corresponds to an initial material points M2. Also, the inventory turnover ratio and the service level ratio of the material information can be forecasted by autoregressive integrated moving average model (ARIMA), and the inventory turnover ratio and the service level ratio of the material information corresponds to an initial material points M3.

Next, the processor 220 respectively calculates the distance between the initial material points M1 and inventory turnover line, the distance between the initial material points M1 and a service level line, the distance between the initial material points M2 and inventory turnover line, the distance between the initial material points M2 and a service level line, the distance between the initial material points M3 and inventory turnover line, and the distance between the initial material points M3 and a service level line. The processor 220 selects the shortest distance of these distances. The processor 220 selects one of the first initial material points to be a first-best material point (e.g. initial material points M1), and the first-best material point have a shortest distance from an inventory turnover line and a service level line. In this example, the shortest distance corresponds to the initial material points M1. Thus, the processor 220 selects the initial material points M1 to be a first-best material point. And, the algorithm of auto-regressive and moving average model (ARMA) corresponding to the initial material points M1 is determined as the best forecasting algorithm of this material information. In other words, the processor 220 determines the algorithm of auto-regressive and moving average model (ARMA) to be the forecasting model of the material information.

For another example, in FIG. 6, the processor 220 performs a calculation according to a plurality of first initial forecasting algorithms (e.g. support vector regression (SVR) and/or auto-regressive and moving average model (ARMA)) applied to the first material information for obtaining a plurality of first initial material points (not shown), the first initial material points respectively corresponds to one of the first initial forecasting algorithms. Then, the processor 220 selects one of the first initial material points (which is the closest to the inventory turnover line and/or the service level line) to be a first-best material point A1 and determines one of the first initial forecasting algorithms corresponded to the first-best material point to be a first-best forecasting algorithm. For example, the first-best material point A1 is forecasted by the auto-regressive and moving average model (ARMA). As such, the auto-regressive and moving average model (ARMA) is determined to be the first-best forecasting algorithm.

For another example, in FIG. 6, the processor 220 performs a calculation according to a plurality of second initial forecasting algorithms (e.g. support vector regression (SVR) and/or autoregressive integrated moving average model (ARIMA)) applied to the second material information for obtaining a plurality of second initial material points (not shown), the second initial material points respectively corresponds to one of the second initial forecasting algorithms. Then, the processor 220 selects one of the second initial material points (which is the closest to the inventory turnover line and/or the service level line) to be a second-best material point A2 and determines one of the second initial forecasting algorithms corresponded to the second-best material point to be a second-best forecasting algorithm. For example, the second-best material point A2 is forecasted by the autoregressive integrated moving average model (ARIMA). As such, the autoregressive integrated moving average model (ARIMA) is determined to be the second-best forecasting algorithm.

According to the above method, the best material point A1-A4, B1-B5 of each material can be determined.

In other words, as shown in FIG. 6, the processor 220 can respectively select the best material point A1-A4, B1-B5 of each material according to the results of each initial forecasting algorithm. Wherein, each one of the best material point A1-A4, B1-B5 respectively corresponds to the best forecasting algorithm.

In step 115, the processor 220 adds the best material points A1, A2, A3 and A4 located in the demand satisfaction range Ra to a first stock group and adds the best material points B1, B2, B3, B4 and B5 located out of the demand satisfaction range Ra to a second stock group.

In step 117, the processor 220 calculates an initial centroid position La of the best material points A1, A2, A3 and A4 in the first stock group.

For example, the one-inventory turnover ratio corresponding to each the best material points A1, A2, A3 and A4 is 11%, 13%, 12% and 14%. The service level ratio corresponding to each the best material points A1, A2, A3 and A4 is 93%, 96%, 92% and 91% In this way, the average one-inventory turnover ratio is 12.5% (that is, (11%+13%+12%+15%)/4=12.5%). The average service level ratio is 93% (that is, (93%+96%+92%+91%)/4=93%). Therefore, the initial centroid position La is located in the position of the one-inventory turnover ratio at 12.5% and the service level ratio at 93%.

In step 119, the processor 220 generates a plurality of first distance indicators according to the best material points B1, B2, B3, B4 and B5 in the second stock group and the initial centroid position La. Wherein, these first distance indicators means the distances between each one of the best material points B1, B2, B3, B4, B5 and initial centroid position La.

In one embodiment, these first distance indicators can be obtained by calculating the absolute value of each one of the results. And, the results is generated by respectively subtracting the initial centroid position La in the position in FIG. 6 from each one of the best material points B1, B2, B3, B4, B5 in the position in FIG. 6. For example, the one-inventory turnover ratio of the best material points B1 is 7%, and the service level ratio is 93%, the distance between the best material points B1 and the initial centroid position La is 4.24. The one-inventory turnover ratio of the best material points B2 is 9%, and the service level ratio is 91%, the distance between the best material points B2 and the initial centroid position La is 1.41. The one-inventory turnover ratio of the best material points B3 is 8%, and the service level ratio is 85%, the distance between the best material points B3 and the initial centroid position La is 5.39. The one-inventory turnover ratio of the best material points B4 is 10.5%, and the service level ratio is 88%, the distance between the best material points B4 and the initial centroid position La is 2.06. The one-inventory turnover ratio of the best material points B5 is 15%, and the service level ratio is 84%, the distance between the best material points B5 and the initial centroid position La is 7.81.

In step 121, the processor 220 determine a shortest one of the first distance indicators to be a first candidate distance (e.g. the first distance indicators of the above mentioned, the distance between the best material points B2 and the initial centroid position La is the shortest (e.g. 1.41). Thus, the first candidate distance is 1.41. The processor 220 determines one of the best material points corresponded to the first candidate distance to be a current material point (e.g. the best material points B2 is determined to be the current material point).

In step 123, the processor 220 adds the current material point to the first stock group, so as to generate a current stock group.

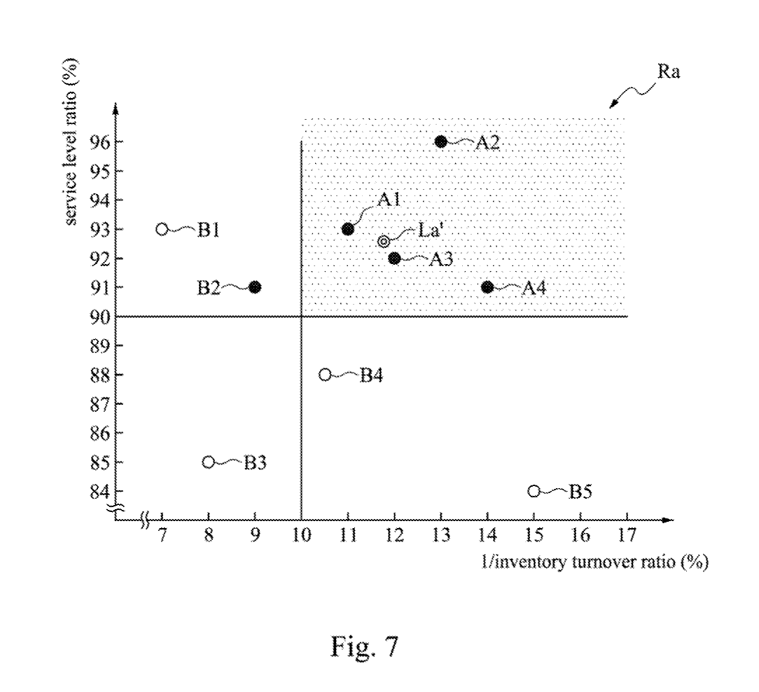

Reference is made to FIG. 7. FIG. 7 illustrates a schematic diagram of material information according to an embodiment of the present invention. In this embodiment, the processor 220 adds the best material points B2 to the first stock group (the first stock group includes the best material points A1-A4). Then, the current stock group is generated. And, the current stock group includes the best material points A1-A4 and B2.

In step 125, due to the processor 220 adds the best material points B2 to the first stock group, the processor 220 removes the current material point B2 from the second stock group. In this moment, the second stock group includes the best material points B1, B3-B5.

In step 127, the processor 220 calculates a current centroid position La′ and determine whether the current centroid position La′ is located in the demand satisfaction range Ra.

If the processor 220 determines that the current centroid position La′ is located in the demand satisfaction range Ra, the step 128 is performed. If the processor 220 determines that the current centroid position La′ is not located in the demand satisfaction range Ra, the step 129 is performed.

In step 128, the processor 220 generates a plurality of distance indicators according to the best material points B1, B3-B5 in the second stock group and the current centroid position La′. And, the processor 220 determines a shortest one of the second distance indicators to be a second candidate distance, and determining one of the best material points (e.g. the best material points B4) corresponded to the second candidate distance to be the current material point. Next, the step 123 is performed.

To be more specifically, in FIG. 7, the processor 220 calculates the current material point La′ of the current stock group (which includes the best material points A1-A4 and B2). The one-inventory turnover ratio of current material point La′ is 11.8%, and the service level ratio is 92.6%. The position of the current material point La′ in FIG. 7 is at (11.8%, 92.6%). In this example, the current material point La′ is located in the demand satisfaction range Ra. Therefore, the processor 220 further calculates a plurality of second distance indicators according to the best material points B1, B3-B5 in the second stock group and the current centroid position La′. And, the processor 220 determines a shortest one of the second distance indicators to be a second candidate distance (e.g. the distance between the best material points B4 and the current centroid position. La′ is the shortest distance, the processor 220 determines this distance to be the second candidate distance).

When the processor 220 determines the shortest one of the second distance indicators is the distance between the best material points B4 and the current centroid position La′, the best material points B4 is determined to be the current material point. Next, the steps 123-127 are performed again.

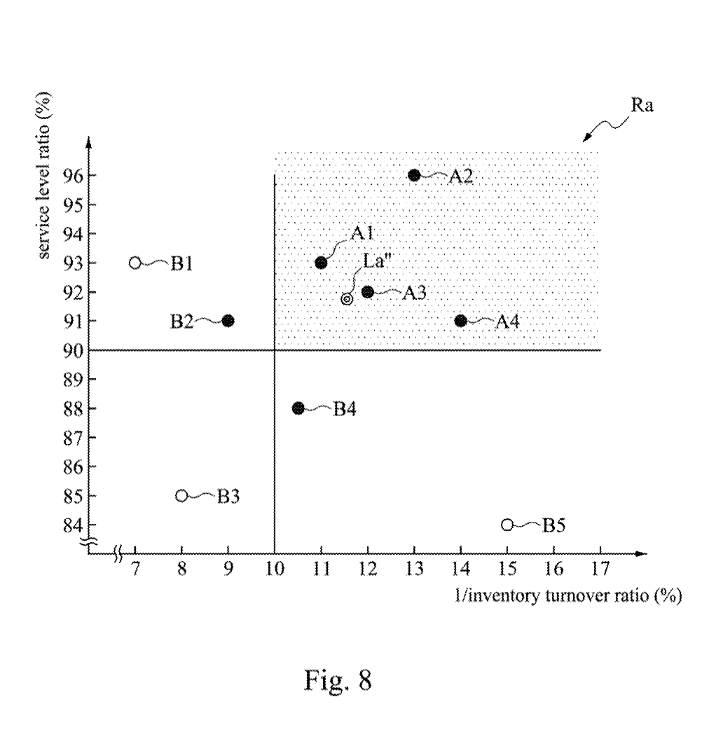

Reference is made to FIG. 8. FIG. 8 illustrates a schematic diagram of material information according to an embodiment of the present invention. In FIG. 8, the distance between the current material point B4 and the current centroid position La′ is the shortest distance. The processor 220 adds the best material points B4 to a first stock group (which includes the best material points A1-A4, B2), so as to generate the current stock group. The current stock group includes the best material points A1-A4, B2 and B4. The processor 220 can calculate a current centroid position La″ of the current stock group (which one-inventory turnover ratio of current material point La″ is 11.58%, and the service level ratio is 91.83%). In this example, the current centroid position La″ is still located in the demand satisfaction range Ra. As such, in step 127, the processor 220 will select “Yes” item and then performs the step 128.

By performing the steps 123-128 repeatedly, until the current centroid position is not located in the demand satisfaction range Ra. When the current centroid position is not located in the demand satisfaction range Ra, the step 129 is performed.

In step 129, when the processor 220 determines that the current centroid position is not located in the demand satisfaction range Ra the processor 220 determines the first stock group and at least one best forecasting algorithm corresponding to the first stock group to be a preparation strategy.

For example, the preparation strategy includes that the best material points A1 of the first stock group, the one-inventory turnover ratio of the best material points A1 is 11%, the service level ratio of the best material points A1 is 93%, the forecasting model of the best material points A1 is the auto-regressive and moving average model (ARMA), the one-inventory turnover ratio of the best material points A2 is 13%, the service level ratio of the best material points A2 is 96%, and the forecasting model of the best material points A1 is the autoregressive integrated moving average model (ARIMA), etc. Therefore, the sales company can consult the preparation strategy to prepare different kinds of materials.

Therefore, through the inventory demand forecasting system and the inventory demand forecasting method can provide the preparation strategy of the materials precisely by considering the inventory turnover ratio and the service level ratio in the same time. Also, it can efficiently adapt the changing market demand, so as to provide the accurate inventory demand forecasting mechanism.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An inventory demand forecasting system, comprising:
a storage, being stored with a plurality of material information, an inventory turnover ratio and a service level ratio; and
a processor, being electrically connected to the storage and configured to executes the following operations:
configuring a demand satisfaction range according to the inventory turnover ratio and the service level ratio;
calculating a plurality of best material points respectively corresponding to the material information;
add the best material points located in the demand satisfaction range to a first stock group and add the best material points located out of the demand satisfaction range to a second stock group;
calculating an initial centroid position of the best material points in the first stock group;
generating a plurality of first distance indicators according to the best material points in the second stock group and the initial centroid position;
determining a shortest one of the first distance indicators to be a first candidate distance, determining one of the best material points corresponded to the first candidate distance to be a current material point, and adding the current material point to the first stock group to generate a current stock group;
removing the current material point from the second stock group; and
calculating a current centroid position and determine whether the current centroid position is located in the demand satisfaction range;
if the current centroid position is located in the demand satisfaction range, the processor generates a plurality of second distance indicators according to the best material points in the second stock group and the current centroid position, determines a shortest one of the second distance indicators to be a second candidate distance, and determines one of the best material points corresponded to the second candidate distance to be the current material point.

2. The inventory demand forecasting system of claim 1, wherein when the processor determines that the current centroid position is not located in the demand satisfaction range the processor determines the first stock group and at least one best forecasting algorithm corresponding to the first stock group to be a preparation strategy.

3. The inventory demand forecasting system of claim 1, wherein the material information comprises a first material information, and the processor further performs a calculation according to a plurality of first initial forecasting algorithms applied to the first material information for obtaining a plurality of first initial material points, the first initial material points respectively corresponds to one of the first initial forecasting algorithms, the processor selects one of the first initial material points to be a first-best material point and determines one of the first initial forecasting algorithms corresponded to the first-best material point to be a first-best forecasting algorithm.

4. The inventory demand forecasting system of claim 3, wherein the material information comprises a second material information, and the processor further performs a calculation according to a plurality of second initial forecasting algorithms applied to the second material information for obtaining a plurality of second initial material points, the second initial material points respectively corresponds to one of the second initial forecasting algorithms, the processor selects one of the second initial material points to be a second-best material point and determines one of the second initial forecasting algorithms corresponded to the second-best material point to be a second-best forecasting algorithm.

5. The inventory demand forecasting system of claim 4, wherein the best material points comprises the first-best material point and the second-best material point.

6. The inventory demand forecasting system of claim 3, wherein the processor selects one of the first initial material points to be a first-best material point, and the first-best material point have a shortest distance from an inventory turnover line and a service level line.

7. The inventory demand forecasting system of claim 1, further comprising:
a transmission device, coupled to the processor and the storage, for receiving the material information from a server.

8. The inventory demand forecasting system of claim 1, wherein the inventory turnover ratio is obtained by dividing a sales quantity of a time interval by an inventory remaining amount of the time interval.

9. The inventory demand forecasting system of claim 1, wherein the service level ratio is determined by an inventory supply directly ratio during a preprocessing period.

10. An inventory demand forecasting method, comprising:
storing a plurality of material information, an inventory turnover ratio and a service level ratio;
configuring a demand satisfaction range according to the inventory turnover ratio and the service level ratio;
calculating a plurality of best material points respectively corresponding to the material information;
adding the best material points located in the demand satisfaction range to a first stock group and add the best material points located out of the demand satisfaction range to a second stock group;
calculating an initial centroid position of the best material points in the first stock group;
generating a plurality of first distance indicators according to the best material points in the second stock group and the initial centroid position;
determining a shortest one of the first distance indicators to be a first candidate distance, determine one of the best material points corresponded to the first candidate distance to be a current material point, and add the current material point to the first stock group to generate a current stock group;
removing the current material point from the second stock group; and
calculating a current centroid position and determine whether the current centroid position is located in the demand satisfaction range;
if the current centroid position is located in the demand satisfaction range, generate a plurality of second distance indicators according to the best material points in the second stock group and the current centroid position, determining a shortest one of the second distance indicators to be a second candidate distance, and determining one of the best material points corresponded to the second candidate distance to be the current material point.

11. The inventory demand forecasting method of claim 10, wherein when a processor determines that the current centroid position is not located in the demand satisfaction range, the processor determines the first stock group and at least one best forecasting algorithm corresponding to the first stock group to be a preparation strategy.

12. The inventory demand forecasting method of claim 10, wherein the material information comprises a first material information, and the inventory demand forecasting method further comprising:
performing a calculation according to a plurality of first initial forecasting algorithms applied to the first material information for obtaining a plurality of first initial material points, the first initial material points respectively corresponds to one of the first initial forecasting algorithms;
selecting one of the first initial material points to be a first-best material point and determines one of the first initial forecasting algorithms corresponded to the first-best material point to be a first-best forecasting algorithm.

13. The inventory demand forecasting method of claim 12, wherein the material information comprises a second material information, and the inventory demand forecasting method further comprising:
performing a calculation according to a plurality of second initial forecasting algorithms applied to the second material information for obtaining a plurality of second initial material points, the second initial material points respectively corresponds to one of the second initial forecasting algorithms;
selecting one of the second initial material points to be a second-best material point and determines one of the second initial forecasting algorithms corresponded to the second-best material point to be a second-best forecasting algorithm.

14. The inventory demand forecasting method of claim 13, wherein the best material points comprises the first-best material point and the second-best material point.

15. The inventory demand forecasting method of claim 12, further comprising:
selecting one of the first initial material points to be a first-best material point, and the first-best material point have a shortest distance from an inventory turnover line and a service level line.

16. The inventory demand forecasting method of claim 10, further comprising:
receiving the material information from a server by a transmission device.

17. The inventory demand forecasting method of claim 10, wherein the inventory turnover ratio is obtained by dividing a sales quantity of a time interval by an inventory remaining amount of the time interval.

18. The inventory demand forecasting method of claim 10, wherein the service level ratio is determined by an inventory supply directly ratio during a preprocessing period.
